(19) United States
(12) Patent Application Publication
(10) Pub. No.: US 2022/0219760 A1
(43) Pub. Date: Jul. 14, 2022

(54) MOTOR VEHICLE STRUCTURE WITH REINFORCING PART BETWEEN THE ROOF CROSSMEMBER AND THE ROOF ARCH BEAM

(71) Applicant: PSA AUTOMOBILES SA, Poissy (FR)

(72) Inventors: Tou THOR, PONT DE ROIDE VERMONDANS (FR); Paul BORNIER, LUZE (FR)

(21) Appl. No.: 17/615,088

(22) PCT Filed: Jun. 8, 2020
(86) PCT No.: PCT/FR2020/050970

§ 371 Date: Nov. 29, 2021

(30) Foreign Application Priority Data
Jun. 19, 2019 (FR) 1906606

(51) Int. Cl. B62D 25/06; B62D 25/04

(52) U.S. Cl. CPC B62D 25/06; B62D 27/023; B62D 25/04

(57) ABSTRACT

Motor vehicle structure, comprising: two roof arch beams (5) arranged laterally one on each side of the motor vehicle structure, a roof crossmember (13), comprising two ends (13A) fastened to the two roof beams (5) respectively, and a reinforcing part (15) for the fastening of each of the ends (13A) of the crossmember (13) to the corresponding roof arch beam (5), each of the ends (13A) of the roof crossmember (13) being arranged between the corresponding reinforcing part (15) and the roof arch beam (5).

### CROSS-REFERENCE TO RELATED APPLICATIONS

This application is the US National Stage under 35 USC § 371 of International Application No. PCT/FR2020/050970, filed 8 Jun. 2020 which claims the priority of the French application 1906606 filed on 19 Jun. 2029, the content (text, drawings and claims) of both said applications being incorporated herein by reference.

### TECHNICAL FIELD

The invention relates to the field of motor vehicles and, more particularly, to the structure of a motor vehicle.

### BACKGROUND

A number of organizations implement test protocols, on behalf of governments, on vehicles, to test the reliability of said vehicles, or indeed theft resistance in the event of an impact. Thus, a “lateral post impact” protocol tests the resistance of the vehicle and the damage suffered by the passengers, in the event of a lateral impact in the region of the lateral central upright or center pillar of the vehicle.

The motor vehicle structure comprises, in a conventional manner, two roof arch beams positioned on either side of a roof. A roof crossmember is positioned below the roof and is fastened laterally to the two roof arch beams. Moreover, a reinforcing part can be used at each of the ends of the crossmember in order to reinforce the connection to the corresponding roof arch beam. However, hi the event of a lateral post impact, the end of the roof crossmember can separate from the corresponding roof arch beam, thus causing injury to the passengers.

FR 2 932 150 A1 discloses a roof crossmember comprising grooves, the crossmember being attached, at each of the ends thereof, to a roof arch beam.

However, the connection between the end of the roof crossmember and the corresponding roof arch beam is fragile.

Indeed, this connection carries a significant risk of rupture in the case of a lateral post impact.

EP 1 449 746 A2 discloses the connection between a lateral central upright, a roof crossmember, and the roof of the motor vehicle. A reinforcing part is positioned between the two panels forming the central lateral upright, and is fastened to the roof crossmember and to the roof. However, this connection may be deficient, in particular in the event of a lateral post impact.

### SUMMARY

The invention aims to overcome at least one of the disadvantages of the prior art mentioned above. More particularly, the invention aims to improve the strength of the connection between the roof crossmember and the roof arch beam, in particular in the case of a lateral post impact.

Briefly, a motor vehicle structure is disclosed, the motor vehicle structure comprising: two roof arch beams arranged laterally on either side of the motor vehicle structure, a roof crossmember comprising two ends which are fastened to the two roof arch beams, respectively, and a reinforcing part for the fastening of each of the ends of the crossmember to the corresponding roof arch beam. Notably, each of the ends of the roof crossmember is arranged between the corresponding reinforcing part and the roof arch beam.

According to an advantageous embodiment, each of the reinforcing parts is a swaged part extending according to a main longitudinal direction of the vehicle, on either side of the corresponding end of the two ends of the roof crossmember.

According to an advantageous embodiment, the two ends of the roof crossmember comprise grooves, each of the reinforcing parts comprising a central portion which fits the grooves of the corresponding end, and two distal portions fastened directly to the corresponding roof arch beam.

According to an advantageous embodiment, the distal portions of each of the reinforcing parts are fastened by one or more electric resistance welding points to the roof arch beam.

According to an advantageous embodiment, the central portion of each of the reinforcing parts is fastened to the corresponding end of the two ends of the roof crossmember by one or more electric resistance welding points.

According to an advantageous embodiment, each of the two ends of the roof crossmember is fastened to the corresponding beam of the two roof arch beams by one or more electric resistance welding points.

According to an advantageous embodiment, each of the reinforcing parts is of a generally rectangular or trapezoidal shape.

According to an advantageous embodiment, each of the reinforcing parts extends laterally beyond the roof arch beam, towards the interior of the vehicle.

According to an advantageous embodiment, the additional extension is at least 15 mm.

According to an advantageous embodiment, the roof crossmember is located longitudinally in the region of two lateral central uprights.

The disclosed structure of the motor vehicle improves the connection between the roof arch beam and the roof crossmember. This improvement is due to the presence of a reinforcing part positioned above each end of the roof crossmember, the reinforcing part being fastened to the corresponding underlying roof arch beam. The positioning of the reinforcing part above each end of the crossmember makes it possible to maintain the connection during the two phases of a lateral post impact: the shearing phase and the traction phase. Moreover, the reinforcing part is simple in design and manufacture, and can be implemented by means of techniques and materials known to a person skilled in the art. The fastening thereof to the structure of the vehicle is also simple to implement, and widely carried out in the motor industry.

Other features and advantages of the structure of the motor vehicle will become clear from the description and the drawings.

### BRIEF DESCRIPTION OF THE DRAWINGS

FIG. 1 is a perspective view of a motor vehicle structure;

FIG. 2 is an exploded view of the connection between a roof arch beam, a roof crossmember, and a reinforcing part;

FIG. 3 is a view from below of the connection shown in FIG. 2;

FIG. 4 is a cross-sectional view of the connection of FIGS. 2 and 3, at a first stage of performance of a lateral post impact: the shearing phase; and

FIG. 5 is a cross-sectional view of the connection of FIGS. 2 and 3, at a second stage of performance of a lateral post impact: the traction phase.

### DETAILED DESCRIPTION

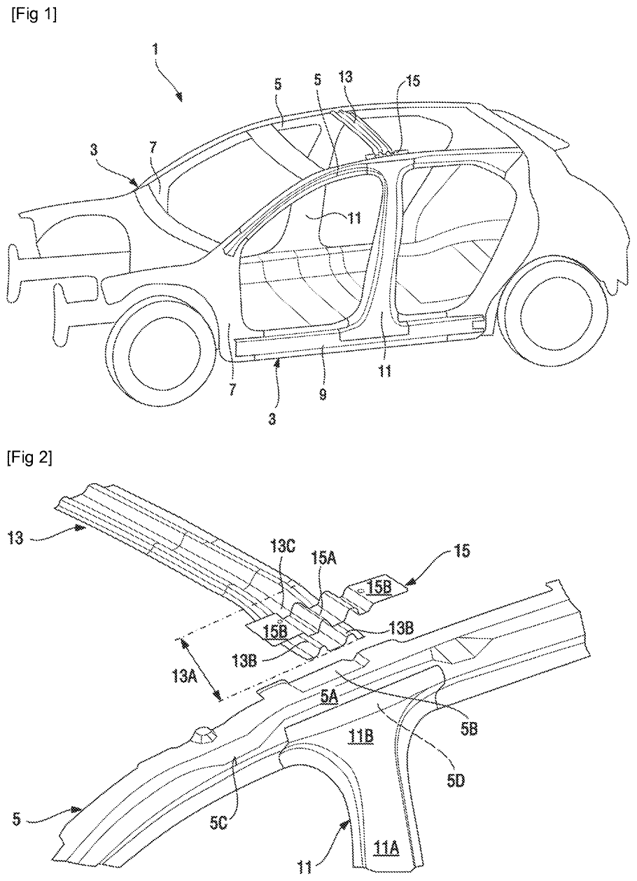

FIG. 1 is a view of a motor vehicle structure.

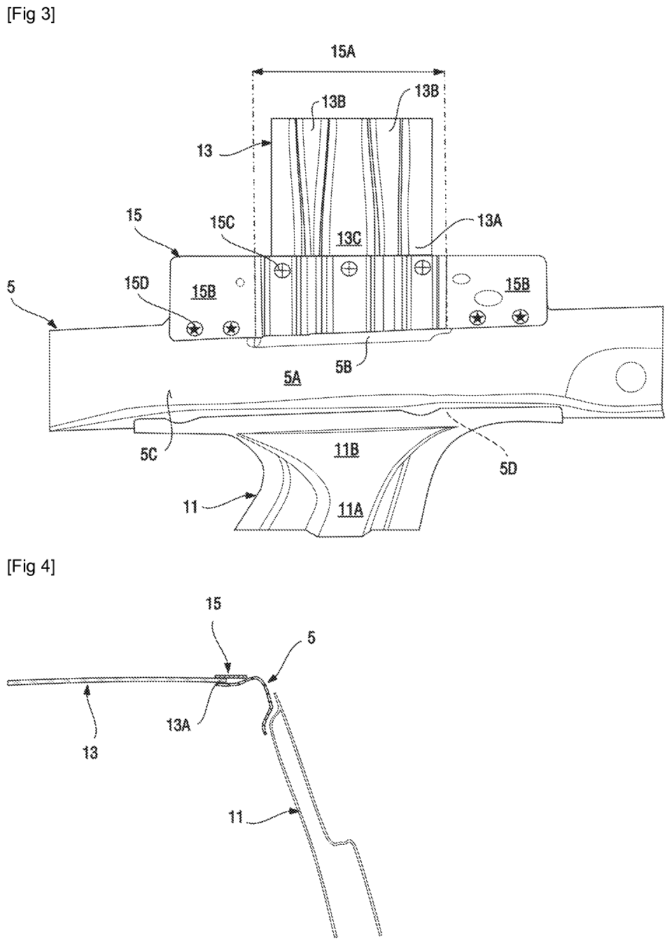

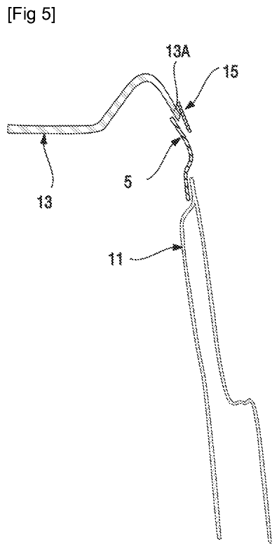

The vehicle structure 1 comprises a roof (not shown, for reasons of clarity) and two lateral sides 3 located on either side of said roof. A roof arch beam 5 is located at each of the lateral sides 3, and laterally at the roof. Said beam 5 extends from a lateral front upright 7, or front foot of the vehicle, towards the rear of the vehicle. Moreover, at each of the sides 3 of the vehicle, a lateral central upright 11, or center pillar, of the vehicle extends from a base 9 towards a mid-portion (shown in FIGS. 2 and 3) and the corresponding roof arch beam 5. A roof crossmember 13 also extends between the two roof arch beams 5 in the region of the lateral central uprights 11. This crossmember 13 comprises two ends (visible in FIGS. 2 and 5), each end of the crossmember 13 being arranged between a reinforcing part 15 and the corresponding roof arch beam 5, each end being fastened to the corresponding beam 5. The reinforcing part 15 serves to fasten each of the ends of the crossmember 13 to the corresponding roof arch beam 5.

FIGS. 2 and 3 are two views of the connection between the corresponding roof crossmember, the roof arch beam, and the reinforcing part. These figures show the connection of the left-hand side of the vehicle, but can also apply to a connection located on the right-hand side of the vehicle.

In these figures, the lateral central upright 11 comprises a vertical portion 11A extending at the height of the structure of the vehicle, and a flared upper end 11B at the junction with the roof arch beam 5. The vertical portion 11A of the lateral central upright 11 has a U-shaped cross section which is capable of improving the absorption of impacts, in particular the absorption of a lateral post impact.

The roof arch beam 5 extends longitudinally along the roof (not visible in these drawings). The roof arch beam 5 has a U-shaped cross section which is capable of improving the absorption of impacts. The mid portion 5A of each beam 5 comprises a reinforcement 5B which is capable of receiving the corresponding end 13A of the roof crossmember 13. A receiving zone 5D for receiving the upper end 11B of the corresponding lateral central upright 11 is located on an outside face 50 of the mid portion 5A of the beam 5. Thus, the roof crossmember 13 is located longitudinally in the region of two lateral central uprights 11.

The end 13A of the roof crossmember 13 comprises, in FIGS. 2 and 3, grooves 13B. Moreover, this end 13A is accommodated in the reinforcement 5B of the roof arch beam 5, and is fastened there by one or more electric resistance welding points 150. A mid portion 130 of the crossmember 13 is cantilevered between the two grooves 13B.

Finally, the connection comprises the reinforcing part 15. Said reinforcing part 15 is a swaged part which is generally rectangular or trapezoidal in shape and which extends according to a main longitudinal direction, on either side of the end 13A of the roof crossmember 13. The reinforcing part 15 comprises a central portion 15A which fits the grooves 13B of the end 13A of the crossmember 13. Said central portion 15A is fastened to the end 13A of the crossmember 13 by one or more electric resistance welding points 150. The reinforcing part 15 furthermore comprises two distal portions 15B which are fastened directly to the roof arch beam 5 by one or more electric resistance welding points 15D. Moreover, the reinforcing part 15 extends laterally beyond the roof arch beam 5, towards the interior of the vehicle, said additional extension being at least 15 mm.

FIGS. 4 and 5 show the connection between an end of the corresponding roof crossmember, the corresponding lateral central upright, and the corresponding roof arch beam, during a lateral post impact.

In a first step (FIG. 4), the connection works in shear. The connection between the roof crossmember 13 and the roof arch beam 5 is maintained by the presence of the reinforcing part 15 which, being positioned on the end 13A of the crossmember 13, keeps the end 13A of the crossmember 13 on the underlying roof arch beam 5 and thus ensures the hold of the connection.

In a second step (FIG. 5), the connection works in traction, following the folding of the roof crossmember 13. This traction phase must occur as late as possible, so as to optimize the function of the crossmember 13. During this phase, the crossmember 13 bears against the reinforcing part 15. The stress is thus distributed over the entire width of the reinforcing part 15, which makes it possible for the connection to be maintained during the second phase of the impact.

### TECHNICAL FIELD

The present invention claims the priority of the French application 1906606 filed on 19 Jun. 2019, the content of which (text, drawings and claims) is incorporated herein by reference.

The invention relates to the field of motor vehicles and, more particularly, to the structure of a motor vehicle.

### PRIOR ART

A number of organizations implement test protocols, on behalf of governments, on vehicles, which protocols serve in particular to test the reliability of said vehicles, or indeed their resistance in the event of an impact. Thus, a “lateral post impact” protocol makes it possible to test the resistance of the vehicle and the damage suffered by the passengers, in the event of a lateral impact in the region of the lateral central upright or center pillar of the vehicle.

The motor vehicle structure comprises, in a conventional manner, two roof arch beams positioned on either side of a roof. A roof crossmember is positioned below the roof and is fastened laterally to the two roof arch beams. Moreover, a reinforcing part can be used at each of the ends of the crossmember in order to reinforce the connection to the corresponding roof arch beam. However, in the event of a lateral post impact, the end of the roof crossmember can separate from the corresponding roof arch beam, thus causing injury to the passengers.

The published patent document FR 2 932 150 A1 discloses a roof crossmember comprising grooves, the crossmember being attached, at each of the ends thereof, to a roof arch beam. However, the connection between the end of the roof crossmember and the corresponding roof arch beam is fragile.

Indeed, this connection carries a significant risk of rupture in the case of a lateral post impact.

The published patent document ER 1 449 746 A2 discloses the connection between a lateral central upright, a roof crossmember, and the roof of the motor vehicle. A reinforcing part is positioned between the two panels forming the central lateral upright, and is fastened to the roof crossmember and to the roof. However, this connection may be deficient, in particular in the event of a lateral post impact.

### DISCLOSURE OF THE INVENTION

The invention aims to overcome at least one of the disadvantages of the prior art mentioned above. More particularly, the invention aims to improve the strength of the connection between the roof crossmember and the roof arch beam, in particular in the case of a lateral post impact.

The invention relates to a motor vehicle structure, comprising: two roof arch beams arranged laterally on either side of the motor vehicle structure, a roof crossmember comprising two ends which are fastened to the two roof arch beams, respectively, and a reinforcing part for the fastening of each of the ends of the crossmember to the corresponding roof arch beam, notable in that each of the ends of the roof crossmember is arranged between the corresponding reinforcing part and the roof arch beam.

According to an advantageous embodiment of the invention, each of the reinforcing parts is a swaged part extending according to a main longitudinal direction, on either side of the corresponding end of the two ends of the roof crossmember.

According to an advantageous embodiment of the invention, the two ends of the roof crossmember comprise grooves, each of the reinforcing parts comprising a central portion which fits the grooves of the corresponding end, and two distal portions fastened directly to the corresponding roof arch beam.

According to an advantageous embodiment of the invention, the distal portions of each of the reinforcing parts are fastened by one or more electric resistance welding points to the roof arch beam.

According to an advantageous embodiment of the invention, the central portion of each of the reinforcing parts is fastened to the corresponding end of the two ends of the roof crossmember by one or more electric resistance welding points.

According to an advantageous embodiment of the invention, each of the two ends of the roof crossmember is fastened to the corresponding beam of the two root arch beams by one or more electric resistance welding points.

According to an advantageous embodiment of the invention, each of the reinforcing parts is of a generally rectangular or trapezoidal shape.

According to an advantageous embodiment of the invention, each of the reinforcing parts extends laterally beyond the roof arch beam, towards the interior of the vehicle.

According to an advantageous embodiment of the invention, the additional extension is at least 15 mm.

According to an advantageous embodiment of the invention, the roof crossmember is located longitudinally in the region of two lateral central uprights.

The measures of the invention are of interest in that they make it possible to improve the connection between the roof arch beam and the roof crossmember. This improvement is due to the presence of a reinforcing part positioned above each end of the roof crossmember, the part being fastened to the corresponding underlying roof arch beam. The positioning of the reinforcing part above each end of the crossmember makes it possible to maintain the connection during the two phases of a lateral post impact: the shearing phase and the traction phase. Moreover, the reinforcing part is simple in design and manufacture, implemented by means of techniques and materials known to a person skilled in the art. The fastening thereof to the structure of the vehicle is also simple to implement, and widely carried out in the motor industry.

Other features and advantages of the present invention will become clear from the description and the drawings.

### BRIEF DESCRIPTION OAF THE DRAWINGS

FIG. 1 is a perspective view of a motor vehicle structure;

FIG. 2 is an exploded view of the connection between a roof arch beam, a roof crossmember, and a reinforcing part;

FIG. 3 is a view from below of the connection shown in FIG. 2;

FIG. 4 is a cross-sectional view of the connection of FIGS. 2 and 3, at a first stage of performance of a lateral post impact: the shearing phase;

FIG. 5 is a cross-sectional view of the connection of FIGS. 2 and 3, at a second stage of performance of a lateral post impact: the traction phase.

### DETAILED DESCRIPTION

FIG. 1 is a view of a motor vehicle structure according to the invention.

The vehicle structure 1 comprises a roof (not shown, for reasons of clarity) and two lateral sides 3 located on either side of said roof. A roof arch beam 5 is located at each of the lateral sides 3, and laterally at the roof. Said beam 5 extends from a lateral front upright 7, or front foot of the vehicle, towards the rear of the vehicle. Moreover, at each of the sides 3 of the vehicle, a lateral central upright 11, or center pillar, of the vehicle extends from a base 9 towards a mid-portion (shown in FIGS. 2 and 3) and the corresponding roof arch beam 5. A roof crossmember 13 also extends between the two roof arch beams 5 in the region of the lateral central uprights 11. This crossmember 13 comprises two ends (visible in FIGS. 2 and 5), each end of the crossmember 13 being arranged between a reinforcing part 15 and the corresponding roof arch beam 5, each end being fastened to the corresponding beam 5. The reinforcing part 15 serves to fasten each of the ends of the crossmember 13 to the corresponding roof arch beam 5.

FIGS. 2 and 3 are two views of the connection between the corresponding roof crossmember, the roof arch beam, and the reinforcing part. These figures show the connection of the left-hand side of the vehicle, but can also apply to a connection located on the right-hand side of the vehicle.

In these figures, the lateral central upright 11 comprises a vertical portion 11A extending at the height of the structure of the vehicle, and a flared upper end 11B at the junction with the roof arch beam 5. The vertical portion 11A of the lateral central upright 11 has a U-shaped cross section which is capable of improving the absorption of impacts, in particular the absorption of a lateral post impact.

The roof arch beam 5 extends longitudinally along the roof (not visible in these drawings). The roof arch beam 5 has a U-shaped cross section which is capable of improving the absorption of impacts. The mid portion 5A of each beam 5 comprises a reinforcement 5B which is capable of receiving the corresponding end 13A of the roof crossmember 13. A receiving zone 5D for receiving the upper end 11B of the corresponding lateral central upright 11 is located on an outside face 5C of the mid portion 5A of the beam 5. Thus, the roof crossmember 13 is located longitudinally in the region of two lateral central uprights 11.

The end 13A of the roof crossmember 13 comprises, in FIGS. 2 and 3, grooves 13B. Moreover, this end 13A is accommodated in the reinforcement 5B of the roof arch beam 5, and is fastened there by one or more electric resistance welding points 150. A mid portion 130 of the crossmember 13 is cantilevered between the two grooves 13B.

Finally, the connection comprises the reinforcing part 15. Said reinforcing part 15 is a swaged part which is generally rectangular or trapezoidal in shape and which extends according to a main longitudinal direction, on either side of the end 13A of the roof crossmember 13. The reinforcing part 15 comprises a central portion 15A which fits the grooves 13B of the end 13A of the crossmember 13. Said central portion 15A is fastened to the end 13A of the crossmember 13 by one or more electric resistance welding points 150. The reinforcing part 15 furthermore comprises two distal portions 15B which are fastened directly to the roof arch beam 5 by one or more electric resistance welding points 15D. Moreover, the reinforcing part 15 extends laterally beyond the roof arch beam 5, towards the interior of the vehicle, said additional extension being at least 15 mm.

FIGS. 4 and 5 show the connection between an end of the corresponding roof crossmember, the corresponding lateral central upright, and the corresponding roof arch beam, during a lateral post impact.

In a first step (FIG. 4), the connection works in shear. The connection between the roof crossmember 13 and the roof arch beam 5 is maintained by the presence of the reinforcing part 15 which, being positioned on the end 13A of the crossmember 13, keeps this on the underlying roof arch beam 5 and thus ensures the hold of the connection.

In a second step (FIG. 5), the connection works in traction, following the folding of the roof crossmember 13. This traction phase must occur as late as possible, so as to optimize the function of the crossmember 13. During this phase, the crossmember 13 bears against the reinforcing part 15. The stress is thus distributed over the entire width of the reinforcing part 15, which makes it possible for the connection to be maintained during the second phase of the impact.

1. A motor vehicle structure, comprising:
two roof arch beams arranged laterally, one on each side of the motor vehicle structure,
a roof crossmember, comprising two ends fastened to the two roof arch beams respectively, and
a reinforcing part for the fastening of each of the ends of the crossmember (13) to the corresponding roof arch beam,
wherein each end of the roof crossmember is arranged between the corresponding reinforcing part and the roof arch beam.

2. The motor vehicle structure according to claim 1, wherein each of the reinforcing parts is a swaged part extending according to a main longitudinal direction, on either side of the corresponding end of the two ends of the roof crossmember.

3. The motor vehicle structure according to claim 1, wherein the two ends of the roof crossmember comprise grooves, each of the reinforcing parts comprising a central portion which fits the grooves of the corresponding end, and two distal portions which are fastened directly to the corresponding roof arch beam.

4. The motor vehicle structure according to claim 3, wherein the distal portions of each of the reinforcing parts are fastened to the roof arch beam by one or more electric resistance welding points.

5. The motor vehicle structure according to claim 3, wherein the central portion of each of the reinforcing parts is fastened to the corresponding end of the two ends of the roof crossmember by one or more electric resistance welding points.

6. The motor vehicle structure according to claim 1, wherein each of the two ends of the roof crossmember is fastened to the corresponding beam of the two roof arch beams by one or more electric resistance welding points.

7. The motor vehicle structure according to claim 1, wherein each of the reinforcing parts is of a generally rectangular or trapezoidal shape.

8. The motor vehicle structure according to claim 1, wherein each of the reinforcing parts extends laterally beyond the roof arch beam towards the interior of the vehicle.

9. The motor vehicle structure according to claim 8, wherein each of the reinforcing parts extends laterally beyond the roof arch beam by at least 15 mm.

10. The motor vehicle structure according to claim 1, wherein the roof crossmember is located longitudinally hi the region of two lateral central uprights.
